(19) United States
(12) Patent Application Publication
(10) Pub. No.: US 2007/0179248 A1
(43) Pub. Date: Aug. 2, 2007

(54) High elongation FKM formulations with improved molding properties

(76) Inventors: James R. Balzer, Howell, MI (US); Roger W. Faulkner, Brighton, MA (US)

Correspondence Address: Brian M. Dingman, Esq.;Mirick, O'Connell, DeMallie & Lougee, LLP, 1700 West Park Drive, Westborough, MA, 01581, US

(21) Appl. No.: 11/346,134

(22) Filed: Feb. 2, 2006

(51) Int. Cl. C08L 27/12

(52) U.S. Cl. 525/199

(57) ABSTRACT

It has been found that certain peroxide/coagent crosslinked blends of a peroxide-crosslinkable FKM fluoroelastomer with a similar non-peroxide crosslinkable FKM fluoroelastomer exhibit increased elongation to rupture, improved demoldability, and slightly reduced durometer compared to prior art peroxide-cured FKMs. The degree to which these desirable changes are realized is greatest when the monomer ratios of the peroxide-crosslinkable FKM fluoroelastomer are similar to the monomer ratios of the non-peroxide crosslinkable FKM. The improved demoldability of these compositions is believed to be due to improved hot tear strength and especially increased elongation at molding temperature; these properties are important in the process of removing complex parts from a mold after forming, whether by compression, transfer, or injection molding. Hot tear strength and elongation are especially important in removal of FKM molded parts with “undercuts” in the mold. In particular, these blends exhibit better demoldability than similar purely peroxide-crosslinked FKM compounds, without being sticky. These compositions are also useful without post cure (as are standard peroxide-cured FKMs, especially those with iodine cure sites).

### FIELD OF THE INVENTION

This invention relates to high-elongation fluoroelastomers.

### BACKGROUND OF THE INVENTION

Elastomers are chemically crosslinked polymers with low crystallinity and glass transition temperatures that are below 0° Celsius. Normally, the chemical crosslinks are introduced by chemical reactions that are thermally activated; such elastomers are known as thermoset elastomers. One important class of thermoset fluorine-containing elastomers (fluoroelastomers) is known generically as FKM. All FKM polymers contain significant monomer residues from vinylidene fluoride (VDF) and hexafluoropropene (HFP). If these are the only monomers used in an FKM polymer, the polymer is known as a “dipolymer FKM.” Dipolymer FKMs are normally crosslinked either with diamines, diamine-donors, or bisphenols. The diamine-based cures also typically include a basic metal oxide or hydroxide (typically MgO). The bisphenol cure systems also include a phase transfer catalyst (typically a quaternary ammonium, phosphonium, or sulfonium salt) and one or more metal oxides/hydroxides (typically a combination of Ca(OH)₂+MgO). For the sake of brevity, these adjunct components of the diamine or bisphenol cure system will not be further mentioned, but are assumed to be present in the relevant cure system.

Another important class of FKM polymers, known as “terpolymers” in the industry, contain a third monomer, tetrafluoroethylene (TFE) in addition to VDF and HFP. FKM terpolymers are also crosslinked by diamine or bisphenol cure systems, but are slightly less reactive and so may require a higher level of onium catalyst or a more active type of onium catalyst to crosslink in an appropriate rapid manner. Neither FKM dipolymers nor FKM terpolymers are reactive with the typical peroxides used to crosslink elastomers, such as dicumyl peroxide or 2,5-Dimethyl-2,5-di(tert-butylperoxy) hexane (DBPH), for example. (FKM dipolymers and terpolymers can react however with highly reactive phenyl free radicals produced by dibenzoylperoxide, for example.)

More complicated FKM polymers are also known and sold commercially. In particular, FKM copolymers may also include polymeric residues from copolymerization of ethylene and/or perfluorovinylethers. The presence of these monomers by themselves do not make the resultant FKM peroxide crosslinkable in a commercially viable way (though FKM polymers containing ethylene are somewhat reactive with peroxides, this monomer by itself does not make an FKM peroxide crosslinkable). Ethylene and/or perfluorovinylethers are primarily incorporated into present generation FKMs to improve low temperature performance and/or base resistance, and are used in copolymers where the FKM also includes special peroxide-reactive cure site monomers. There is no technical reason that copolymers incorporating ethylene and/or perfluorovinylethers, but no peroxide-reactive sites could not be made. The special peroxide-reactive cure site monomers typically contain labile bromine or iodine atoms, or in some cases reactive double bonds.

One raw material used in preferred embodiments of this invention are the iodine-terminated peroxide-curable FKMs of U.S. Pat. No. 4,158,678 (Tatemoto & Nakagawa, assigned to Daikin). These polymers have iodine groups on the chain termini (i.e., they are “telechelic” polymers). The reactivity of the iodine terminal groups is very high, so that substantially all of them can be incorporated into crosslinks. Some of these polymers also have additional labile iodine cure sites due to polymer chain branching. These polymers have the property that, provided there is enough peroxide and coagent to cause the reaction of all the iodine-functional end groups into the elastomer network, adding more peroxide & coagent has little additional effect on crosslink density. Other types of peroxide crosslinkable FKMs that incorporate iodine or bromine cure sites, or reactive double bonds can also be used in the present invention.

Hot tear strength and elongation to break at molding temperatures are particular problems for FKMs. Usually, the optimum crosslink density or “state of cure” for best in-service properties is higher than the optimum state of cure for demolding (removal of hot molded parts from the mold). Demolding problems occur for two basic reasons: low tear strength at elevated temperatures, and low elongation to break at elevated temperatures. Demolding becomes a major issue when complex parts are being molded, especially parts where the mold contains “undercuts.” (undercuts refer to portions of the mold wherein the molded rubber part has to deform around a part of the mold that sticks in from the edge, in order to remove the part from the mold.) Molded FKM must stretch around the undercuts to be removed from the mold, which implies significant elongation in a hot, relatively weak state. Elongation, tear strength, and adhesion to the mold at molding temperature are all important factors in efficient demolding.

Bisphenol-cured or amine-donor cured FKMs have an advantage over peroxide-cured FKMs in terms of hot tear strength and elongation at molding temperatures, and therefore also ease of demolding. This is the case in part because the cure reactions of bisphenol or amine-cured FKMs are (usually) relatively slower than the typical peroxide curing reactions; therefore the parts can usually be removed from the mold before they are fully cured, in the sense of the theoretical press-cure as determined by a cure meter, such as an oscillating disk rheometer (ODR) or a moving die rheometer (MDR), for example the Monsanto oscillating disk rheometer. Often, bisphenol- and diamine-cured FKM compounds are demolded at 50-70% of theoretical full cure based on the ODR results, so that removal from the mold and cycle time are improved.

Bisphenol or amine-cured FKMs are almost always post-cured for at least 4 hours, and usually at temperatures (225-260° C.) that are well above the molding temperature (160-190° C.). Oxygen from the air does not inhibit either bisphenol or diamine curing of FKM, so there is no problem with completing the press curing reactions during the post-cure. Even if a bisphenol or diamine-cured FKM does reach its full theoretical press cure state during molding, a significant portion of the total crosslinking reactions occur during the post-cure (by different, slower chemical means), which implies a relatively lower cure state when the FKM part is demolded compared to the final cure state when the part is used. This helps demolding.

Peroxide-cured FKMs by contrast are normally taken to their fully cured state in the mold. In part, this is because oxygen from the air inhibits peroxide crosslinking, so it is not desirable to finish peroxide based curing processes during post-cure; attempting to do so can result in a tacky or under-cured surface due to oxygen inhibition of curing at the surface after demolding. Also, the peroxide initiator is consumed in a very short time at typical post-cure temperatures relative to the time of a typical post-cure, and there is relatively little desirable reorganization of the formed crosslinks during post-cure (unlike bisphenol- or diamine-cured FKM). The peroxide curing reactions are relatively fast, however, so there is not much of a molding time penalty for finishing the initial cure in the press. Also, since there is very little additional curing during the post-cure (especially compared to bisphenol-cured FKMs), peroxide-cured FKMs are often processed without a post-cure. The fact that peroxide-cured FKMs can often be processed with “no post-cure” (NPC) is in fact a major selling point and commercial advantage of these FKMs. Note though, that NPC processing implies that the FKM part must be demolded in a fully cured state; this often results in significant scrap due to tearing of the parts during demolding. Therefore a method to improve demoldability of peroxide-cured FKM is especially desirable.

Various prior art means to improve hot tear strength of elastomers are known. Lowering the total cure state helps demolding, but is often not feasible because this also interferes with key final properties such as compression set resistance. In the case of the telechelic iodine-cure site polymers of U.S. Pat. No. 4,158,678, it is particularly undesirable to improve hot tear strength by reducing crosslink density, because this leads to a large increase of network defects, wherein an iodine-functional cure site fails to attach to the network; under-curing such a polymer leads to numerous “dangling ends” which counteract the intrinsic advantages of the telechelic polymer architecture.

Various high-structure fillers, e.g. precipitated silica, polyaramid pulp, and/or high structure carbon black improve both room temperature and high temperature tear strength of elastomers; however these reinforcing fillers are rarely used in fluoroelastomers for various reasons, especially their negative effects on compression set resistance and ultimate elongation. Precipitated silica and high structure carbon black are also known to interfere with peroxide crosslinking.

Rubber-rubber dynamic vulcanization is another known means to improve tear strength, including hot tear strength, though this has not been the primary motivation for performing rubber-rubber dynamic vulcanization. Examples of this approach include various patents of Aubert Coran (for example, U.S. Pat. Nos. 4,687,810, 4,792,583, 5,036,132, 5,051,480, and 5,053,450), assigned to Monsanto Company, Inc.; also U.S. Pat. No. 6342567 of Minagawa et al, assigned to Sumitomo Rubber Industries, Ltd.; and U.S. Pat. 6,403,722 of Severe and White, assigned to The University of Akron. U.S. Pat. No. 6,737,479 by Roger Faulkner on “Dynamically Cured Fluoroelastomer Blends,” assigned to Cri-Tech Inc., deals with a purely fluoroelastomer based dynamic vulcanizate which does exhibit moderately improved tear strength, both at room temperature and at molding temperature. The dynamic vulcanizates of U.S. Pat. No. 6,737,479 comprise dynamically vulcanized blends of non-miscible FKM polymers with substantially different monomer compositions. The FKM/FKM dynamic vulcanizates of U.S. Pat. No. 6,737,479 do not exhibit improved elongation to break compared to standard FKMs.

Another commercially important limitation of FKM elastomers is that it has heretofore been impossible to obtain strong well-cured FKM elastomers with elongation to break above 400%. Although fluoroelastomers are rarely used at high strain, a high elongation to break can be useful in assembly of multi-component systems and/or demolding of complex parts.

### SUMMARY OF THE INVENTION

It has been found that addition of about 2 to about 50% by polymer weight percent (more preferably 5-40%) of a compatible, non-peroxide curable gum FKM (a non-curing FKM diluent polymer) into a peroxide/coagent curing FKM compound leads to a surprising and technologically important increase of demolding elongation and ease of removal from a mold. Addition of a non-curing FKM diluent polymer to a peroxide-curable FKM can also lead to increased strength at molding (and use) temperatures. The resultant parts are not tacky or sticky, nor do they leave residues when rubbed against solid surfaces, as would be expected if the curing and non-curing FKMs were not compatible. Addition of the non-curing diluent FKM also increases elongation to break at room temperature, in some cases beyond 500%, and can lead to useful FKM compounds with reduced low strain modulus, and slightly reduced Shore A durometer. It is hypothesized, but not yet proven, that at least some of the novel blends are miscible on a molecular level.

In those cases in which peroxide-reactive cure sites are incorporated into an FKM elastomer, the level of peroxide-reactive cure sites is rather low, typically less than 2% by weight of the total polymer. The addition of such a small amount of added monomer has only a very small effect on the solubility characteristics of the polymer, such that miscible polymer blends of one or more peroxide-curable FKMs with one or more non-peroxide-curable FKMs can occur, provided the two or more FKM elastomers have similar ratios of the major constituent monomers (other than the peroxide cure site monomer).

It has been found that in blends of two FKM polymers containing the same major monomers, matching the percent fluorine between the peroxide curable FKM and the non-peroxide curable diluent FKM yields desirable examples of blends of this invention. FKM polymer suppliers do not normally report monomer ratios, but they do report weight % fluorine and low temperature flexibility. Although in principle the same weight % fluorine can be attained with quite different monomer ratios in a system with three or more monomers, adding the constraint of matching T_{g} effectively implies that the two polymers have nearly the same monomer ratio.

In general, if the low temperature flexibility (e.g., glass transition temperature T_{g}) and weight percent fluorine are matched between a peroxide-curable and non-peroxide curable FKM, then these two FKM polymers are compatible for purposes of this invention, and may even be molecularly miscible. Type A fluoroelastomers with specialized “X” cure sites can be usefully blended with similar Type B fluoroelastomers that are compatible or preferably miscible with Type A fluoroelastomers, but which lack the X cure site. Although the examples we present involve FKM elastomers in which the Type A fluoroelastomer contains labile iodine cure sites, while the Type B fluoroelastomer does not contain labile iodine cure sites, other examples of Type A and Type B fluoroelastomers are readily apparent to one skilled in the art of polymer science, once the concept embodied in this invention is known. One readily apparent example is that any alternative means of rendering an FKM polymer curable by peroxides (such as labile bromine cure sites or reactive double bonds) can also be used as the X cure sites in a Type A FKM, which may then be blended with compatible, non-peroxide curable FKMs. It is only slightly less obvious that different types of non-peroxide sensitive cure sites can also be incorporated in a Type A fluoroelastomer, which may then usefully be blended with a Type B fluoroelastomer per the present invention. Type A and Type B fluoroelastomers can be perfluoroelastomers of various kinds, fluorosilicones, or copolymers of tetrafluoroethylene and polypropylene for example.

The present invention is not limited to currently commercially available fluoroelastomers. For example, FFKM perfluoroelastomers (which are made by DuPont, Daikin, and Solvay Solexis; Kalrez™ for example) consist primarily of copolymers of tetrafluoroethylene (TFE), hexafluoropropene (HFP), and perfluoroalkylvinylethers (PMVE, perfluoromethylvinylether or PPVE, perfluoropropylvinylether), with an added cure site. At present the added cure sites contain either labile halogen (iodine or bromine) to make the FFKM peroxide curable, or a nitrile group, which can lead to crosslinking by several distinct condensation reactions that do not involve peroxide catalysts. FFKM without cure sites is not commercially available, so we were not able to demonstrate that the present invention can also be used to improve the molding properties and/or high temperature strength of FFKM blends, by blending a Type A cure-site containing FFKM with a Type B, non-cure site containing FFKM. We fully expect our invention to work in FFKM polymers however, either for the peroxide-crosslinked materials or the nitrile-crosslinked materials. This would also be the case if a special grade of FFKM or FKM with a novel cure site, such as an acetylene group for example, were introduced. Similarly, although nitrile cure sites are not at present available in FKM, if such a nitrile-FKM should become available, we believe that such a polymer could be the Type A fluoroelastomer of the present invention, and could usefully be blended with a nitrile-free compatible FKM per the present invention to gain the advantages enumerated herein.

Similarly, the present invention is applicable to copolymers of tetrafluoroethylene and polypropylene (Aflas™ for example) in principle, but since there are not available grades of Aflas™ that are devoid of cure sites, it has not been possible to demonstrate this.

In the novel compatible FKM blends of the present invention, the non-peroxide-crosslinkable FKM is acting as a polymeric plasticizer for the fully crosslinked peroxide cured FKM polymer. The resultant polymer architecture is unique, and very different than a conventional FKM compound with the same average crosslink density. In the novel blends of this invention, a well-formed network of the peroxide/coagent crosslinked FKM is molecularly, or at least intimately, diluted by a very similar, but non-curing FKM.

### DETAILED DESCRIPTION OF THE PREFERRED EMBODIMENTS OF THE INVENTION

Examples of the Invention

A standard peroxide cure FKM injection molding compound is shown in Table 1, Compound #1. This compound has excellent physical properties, but is rather difficult to demold due to its poor tear strength and low elongation to break at elevated temperature. Table 1, Compounds #2-6 are all examples of the present invention in which a non-curing gum FKM is used to dilute Compound #1. All the compounds have the same filler levels, and the peroxide and coagent (TAIC) levels are kept in constant proportion to the peroxide-crosslinkable FKM.

TABLE 1
Examples #1 to #6

| | #1 | #2 | #3 | #4 | #5 | #6 |
|---|---|---|---|---|---|---|
| INGREDIENT: | | | | | | |
| Dai-El G901 71% F peroxide-cure terpolymer | 100.00 | 65.00 | 65.00 | 65.00 | 65.00 | 65.00 |
| Dai-El G-501NK 68% F (terpolymer gum) | — | 35.00 | — | — | — | — |
| Dai-El G-701-BP (dipolymer gum) | — | — | 35.00 | — | — | — |
| Dai-El G755-BP (dipolymer gum) | — | — | — | — | — | — |
| Dai-El G-7800-BP (dipolymer gum) | — | — | — | 35.00 | — | — |
| Dai-El G-621-BP 71% F (terpolymer gum) | — | — | — | — | 35.00 | — |
| Dai-El G-603-BP 71% F (terpolymer gum) | — | — | — | — | — | 35.00 |
| N-990 carbon black | 20.00 | 20.00 | 20.00 | 20.00 | 20.00 | 20.00 |
| Zinc oxide Kadox 911 | 5.00 | 5.00 | 5.00 | 5.00 | 5.00 | 5.00 |
| TAIC-DLC-A (72% triallylisocyanurate on silica) | 4.00 | 2.60 | 2.60 | 2.60 | 2.60 | 2.60 |
| Varox DBPH-50-HP | 1.50 | 0.98 | 0.98 | 0.98 | 0.98 | 0.98 |
| MDR cure characteristics (10 minutes @ 177° C.) | | | | | | |
| Minimum S′ (storage modulus, decinewton-meters, dNm) | 2.33 | 4.57 | 3.56 | 4.13 | 3.00 | 2.43 |
| Maximum S′ (storage modulus, dNm) | 75.57 | 38.83 | 28.49 | 34.48 | 40.10 | 37.69 |
| Time (minutes) for 10% of cure to occur | 0.52 | 0.49 | 0.5 | 0.47 | 0.55 | 0.48 |
| Time (minutes) for 90% of cure to occur | 1.13 | 1.13 | 1.14 | 1.12 | 1.43 | 1.14 |
| Press-cure (10 minutes @ 160 C.) | | | | | | |
| Shore A durometer | 68 | 65 | 65 | 66 | 67 | 67 |
| Tensile Strength (MPa) | 14.85 | 7.03 | 4.47 | 7.75 | 10.98 | 8.27 |
| Elongation (%) | 258 | 424 | 353 | 435 | 343 | 323 |
| 100% modulus (stress in MPa at 100% strain) | 3.01 | 2.06 | 1.80 | 1.87 | 2.71 | 2.34 |
| Post-cure (4 hours @ 215 C.) | | | | | | |
| Shore A durometer | 69 | 65 | 64 | 67 | 67 | 66 |
| Tensile Strength (MPa) | 17.55 | 9.02 | 7.49 | 7.36 | 11.21 | 10.34 |
| Elongation (%) | 325 | 451 | 482 | 466 | 415 | 418 |
| 100% modulus (stress in MPa at 100% strain) | 2.93 | 2.05 | 1.63 | 1.76 | 2.52 | 2.33 |
| ASTM 642C Die C tear, kN/m | 19.32 | 20.65 | 17.96 | 18.99 | 20.11 | 21.82 |
| Compression set, 22 hours @ 200° C. | 14.2% | 31.5% | 39.2% | 30.4% | 25.0% | 23.1% |

Among the compounds of Table 1, the best match of combined fluorine level and Tg between the peroxide-cured FKM (Dai-El G-901) and the non-curing diluent polymer occurs for compounds #5 and #6; these compounds also had the best balance of physical properties, especially tensile strength and compression set. Durometer was not reduced very much by dilution of the peroxide crosslinkable FKM, but 100% modulus was significantly reduced. Tear strength at room temperature was improved, most notably for compound #6.

Table 2 illustrates additional examples of the present invention. Compounds #7 and #9 are controls, and are not examples of the present invention. Compound #8 is particularly interesting, in that it achieved an elongation of 600% (at room temperature) compared to about 435% for the control Compound #7. Compound #8 also had the smallest proportional increase of compression set for any of the comparable examples (i.e., 35% diluent FKM) of the present invention for which properties were measured; it is believed that the molecular similarity of Dai-El G-801 and Dai-El G-7800-BP are responsible for the exceptional properties of Compound #8.

TABLE 2
Examples #7 to #12

| | #7 | #8 | #9 | #10 | #11 | #12 |
|---|---|---|---|---|---|---|
| INGREDIENT: | | | | | | |
| Dai-El G801 (peroxide-curable) | 100.00 | 65.00 | — | — | — | — |
| Dai-El G901 GP (peroxide-curable) | — | — | — | — | 90.00 | 80.00 |
| Dai-El G912 tri-branched (peroxide-curable) | — | — | 100.00 | 65.00 | — | — |
| Dai-El G-701-BP (gum) | — | — | — | 35.00 | — | — |
| Dai-El G-7800-BP (gum) | — | 35.00 | — | — | — | — |
| Dai-El G-621-BP (gum) | — | — | — | — | 10.00 | 20.00 |
| N-990 carbon black | 20.00 | 20.00 | 20.00 | 20.00 | 20.00 | 20.00 |
| Zinc oxide Kadox 911 | 5.00 | 5.00 | 5.00 | 5.00 | 5.00 | 5.00 |
| TAIC-DLC-A (72% triallylisocyanurate on silica) | 4.00 | 2.60 | 4.00 | 2.60 | 3.60 | 3.20 |
| Varox DBPH-50-HP | 1.50 | 0.98 | 1.50 | 0.98 | 1.35 | 1.20 |
| MDR cure characteristics (10 minutes @ 177° C.) | | | | | | |
| Minimum S′ (storage modulus, dNm) | 2.14 | 3.35 | 4.54 | 4.87 | 2.77 | 2.87 |
| Maximum S′ (storage modulus, dNm) | 54.32 | 30.5 | 85.62 | 33.99 | 63.28 | 53.86 |
| Time (minutes) for 10% of cure to occur | .51 | .59 | .46 | .46 | .54 | .53 |
| Time (minutes) for 90% of cure to occur | 1.13 | 1.39 | 1.00 | 1.21 | 1.19 | 1.24 |
| Press-cure (10 minutes @ 160° C.) | | | | | | |
| Shore A durometer | 64 | 59 | 68 | 65 | 67 | 68 |
| Tensile Strength (MPa) | 13.67 | 9.20 | 12.98 | 8.75 | 13.69 | 12.85 |
| Elongation (%) | 404 | 599 | 143 | 264 | 328 | 362 |
| 100% modulus (stress in Mpa at 100% strain) | 2.03 | 1.68 | 7.20 | 2.40 | 2.65 | 2.60 |
| Post-cure (4 hours @ 215 C.) | | | | | | |
| Shore A durometer | 65 | 61 | 70 | 66 | 68 | 69 |
| Tensile Strength (MPa) | 15.91 | 10.98 | 16.73 | 8.83 | 15.14 | 13.44 |
| Elongation (%) | 437 | 599 | 158 | 242 | 312 | 326 |
| 100% modulus (stress in Mpa at 100% strain) | 2.13 | 1.72 | 8.07 | 2.88 | 2.82 | 2.50 |
| ASTM Die C tear, kN/m | 20.90 | 23.23 | 16.65 | 19.90 | 21.82 | 20.30 |
| Compression set, 22 hours @ 200° C. | 17.3% | 22.9% | 7.3% | 18.5% | 12.0% | 18.6% |

As with the compounds of Table 1, all the compounds of Table 2 have the same filler levels, and the peroxide and coagent (TAIC) levels are kept in constant proportion to the peroxide-crosslinkable FKM.

The compounds of Table 2 (#7-12) were cured on a Monsanto oscillating disc rheometer (ODR) as a way of estimating the demoldability. Compounds #7, #9, and #11 were impossible to remove from the Monsanto oscillating disc rheometer (ODR) spindle (the oscillating disc) without tearing the specimens essentially in half along their midline after crosslinking, but the four other compounds (which are examples of the present invention) could readily be removed from the ODR, and taken off the ODR spindle with only minor tearing, and without cooling the spindle. It is noteworthy that Compound #11, which only had 10% non-curing diluent FKM, had essentially the same tendency to tear as Compound #1 (the control), but Compound #12 (containing 20% non-curing diluent FKM) had significantly better hot tear resistance and demoldability than the control, similar to Compound #6 (which contained 35% non-curing diluent FKM).

Compounds #1, #11, #12, and #5 are (in that order) examples of increasing degrees of dilution of a peroxide-cured FKM (Dai-El G-901) with a non-curing compatible FKM (Dai-El G-621-BP). Comparing Compounds #1 vs. #11 indicates that low level addition (10%) of non-curing diluent FKM into a peroxide-cured FKM has no negative impact on compression set under the cited conditions (22 hours @200° C.), and had only a small effect on elongation to break at room temperature; however, the addition of only 10% of compatible diluent FKM did not improve demoldability as estimated by the ability to remove the cured sample from the ODR spindle hot.

Table 3 illustrates additional examples of the present invention. The examples of Table 3 are not preferred embodiments of the invention insofar as there is a substantial difference of monomer composition between the major peroxide curable FKM and the minor diluent FKM.

TABLE 3
Examples #13 to #18

| | #13 | #14 | #15 | #16 | #17 | #18 |
|---|---|---|---|---|---|---|
| INGREDIENT: | | | | | | |
| Dai-El G999 (73% fluorine, 21 Mooney) (peroxide | — | — | — | — | 100.00 | 75.00 |
| curable) | | | | | | |
| Technoflon PL 855 (65% fluorine) (peroxide curable) | 100.00 | 75.00 | — | — | — | — |
| Technoflon PL 958 (67% fluorine) (peroxide curable) | — | — | 100.00 | 75.00 | — | — |
| Dai-El G-7800-BP (gum) | — | 25.00 | — | 25.00 | — | — |
| Dai-El G-603-BP (gum) | — | — | — | — | — | 25.00 |
| N-990 carbon black | 20.00 | 20.00 | 20.00 | 20.00 | 20.00 | 20.00 |
| Zinc oxide Kadox 911 | 5.00 | 5.00 | 5.00 | 5.00 | 5.00 | 5.00 |
| TAIC-DLC-A (72% triallylisocyanurate on silica) | 4.00 | 2.60 | 4.00 | 2.60 | 4.00 | 2.60 |
| Varox DBPH-50-HP | 1.50 | 0.98 | 1.50 | 0.98 | 1.50 | 0.98 |
| Post-cure (4 hours @ 215 C., after 10 min. @ 160° C.) | | | | | | |
| Shore A durometer | 62 | 60 | 63 | 61 | 86 | 80 |
| Tensile Strength (MPa) | 10.65 | 8.67 | 11.00 | 7.94 | 17.2 | 9.09 |
| Elongation (%) | 224 | 305 | 180 | 230 | 302 | 365 |
| 100% modulus (stress in MPa at 100% strain) | 2.50 | 1.72 | 3.59 | 2.40 | 5.47 | 3.02 |

Even though compounds #14, #16, and #18 of Table 3 are not preferred examples of the present invention, all exhibit increased elongation to break. All had noticeably less tearing of ODR cured specimens during removal from the spindle than the controls (Compounds #13, #16, and #17). It is anticipated that if non-peroxide curable FKM polymers were available that matched the monomer compositions of the special peroxide-curable FKMs of Table 3 (Technoflon PL 855, Technoflon PL 958, and/or Dai-El G999), it would be possible to achieve better properties.

The compounds of Table 4 (#19-24) show how physical properties vary with the ratio of peroxide curable FKM to non-peroxide curable FKM, for a particular, desirable pair of FKM polymers of this invention. These compounds are at the soft, low-stiffness end of the FKM spectrum. At room temperature, there was little increase in elongation with increasing dilution of the peroxide curable FKM with the non-peroxide curable FKM, up to 20% dilution (compound #21). For compounds #22-24, there was an improvement in elongation to break at room temperature, and this resulted in significantly improved demoldability at 177° C., as assessed by removal of the hot sample from the test spindle of the Monsanto R-100 ODR. Ease of removal of the test specimens from the hot spindle improved as a function of increased dilution for compounds #22-24. Removal from the ODR spindle without tearing has proved to be a valuable predictor of moldability in molds having an undercut.

TABLE 4
Examples #19 to #24

| | #19 | #20 | #21 | #22 | #23 | #24 |
|---|---|---|---|---|---|---|
| INGREDIENT: | | | | | | |
| Dai-El G801 (peroxide-curable) | 100.0 | 90.0 | 80.0 | 70.0 | 60.0 | 50.0 |
| Dai-El G-7800-BP (gum) | 0.0 | 10.0 | 20.0 | 30.0 | 40.0 | 50.0 |
| N-550 | 4.0 | 4.0 | 4.0 | 4.0 | 4.0 | 4.0 |
| TAIC-DLC-A (72%) | 4.0 | 4.0 | 4.0 | 4.0 | 4.0 | 4.0 |
| Varox DBPH-50-HP | 1.5 | 1.5 | 1.5 | 1.5 | 1.5 | 1.5 |
| Total: | 109.5 | 109.5 | 109.5 | 109.5 | 109.5 | 109.5 |
| Post-cure (4 hours @ 215 C., after 10 min. @ 160° C.) | | | | | | |
| Shore A durometer | 63 | 65 | 63 | 65 | 65 | 65 |
| Tensile Strength (MPa) | 13.67 | 13.16 | 12.38 | 11.84 | 11.00 | 9.09 |
| Elongation (%) | 463 | 457 | 464 | 479 | 508 | 651 |
| 100% modulus (stress in MPa at 100% strain) | 1.77 | 1.70 | 1.72 | 1.68 | 1.68 | 1.53 |

Table 5 gives hot tensile data (at 177° C.) for FKM elastomers of the present invention. Compound #25 is a control compound, which elongated only 94% at 177° C. (a typical molding temperature). Adding only 5% of a non-curing diluent FKM increased the hot (177° C.) elongation of Compound #26 to 134%. Diluting further, to 10% or 20% increased hot elongation of Compounds #27 and #28 only a little more, to 141% and 145% respectively. The slight reduction of coagent (TAIC-DLC-A) level in Compound #29 from 4.0 to 3.5 reduced rather than increased hot elongation. It is interesting to note that when barium sulfate is substituted for carbon black on an equal volume basis (Compound #30), elongation at room temperature increases, but hot elongation is reduced.

TABLE 5
Examples #25 to #30

| | Example #'s: | | | | | |
|---|---|---|---|---|---|---|
| | #25 | #26 | #27 | #28 | #29 | #30 |
| G-7800BP (gum) | | 5 | 10 | 20 | 10 | 10 |
| DAI-EL G-802 (peroxide curable) | 100 | 95 | 90 | 80 | 90 | 90 |
| Carbon Black N-990 | 20 | 20 | 20 | 20 | 20 | |
| Blanc Fixe Micro | | | | | | 48 |
| TAIC DLC A | 4 | 4 | 4 | 4 | 3.5 | 4 |
| Varox DBPH 50 HP | 3 | 3 | 3 | 3 | 3 | 3 |
| Struktol WS280 | 0.5 | 0.5 | 0.5 | 0.5 | 0.5 | 0.5 |
| Rheology 10 Minutes @ 188° C. | | | | | | |
| ML, dNm | 0.623 | 0.651 | 0.843 | 1.007 | 0.788 | 0.903 |
| TS2, minutes | 0.456 | 0.457 | 0.476 | 0.46 | 0.455 | 0.365 |
| TC90, minutes | 0.89 | 1.01 | 0.94 | 0.95 | 0.97 | 0.74 |
| MH, dNm | 54.35 | 52.69 | 42.66 | 43.82 | 49.01 | 53.86 |
| Room Temperature Properties | | | | | | |
| Cured 5 Minutes @ 188° C. | | | | | | |
| Durometer, Shore A | 61 | 61 | 58 | 60 | 61 | 62 |
| Tensile Strength, MPa | 15.5 | 13.2 | 13.6 | 13.5 | 12.8 | 10.4 |
| Elongation, % | 446 | 438 | 436 | 489 | 431 | 539 |
| 50% Modulus, MPa | No | 1.2 | No | 1.1 | 1.2 | 1.2 |
| | data | | data | | | |
| 100% Modulus, MPa | No | 1.6 | No | 1.5 | 1.6 | 1.7 |
| | data | | data | | | |
| Hot Properties @ 177° C. | | | | | | |
| Tensile Strength, MPa | 1.7 | 2.2 | 1.6 | 1.8 | 1.9 | 1.5 |
| Elongation, % | 94 | 134 | 141 | 145 | 129 | 103 |
| 50% Modulus, MPa | No | 1.1 | No | 0.9 | 1 | 1.1 |
| | data | | data | | | |
| 100% Modulus, MPa | No | 1.7 | No | 1.4 | 1.5 | 1.5 |
| | data | | data | | | |

It is interesting to note that tensile strength at 177° C. was a maximum for the sample (Compound #26) that contained only 5% of a non-curing diluent FKM. This sample also had a 42% increase in hot elongation. This shows that the invention has utility even at low levels of addition of a non-curing curing diluent FKM. It is apparent that for some specialized purposes, non-curing diluent FKM levels below 5% of total FKM are useful.

What is claimed is:

1. A fluoroelastomer blend in which less than all of the total fluoroelastomer is one or more Type A fluoroelastomers that crosslink during the curing process, and at least some of the rest of the total fluoroelastomer is a different, non-curing, Type B fluoroelastomer.

2. The fluoroelastomer blend of claim 1 in which at least 50% of the total fluoroelastomer is one or more Type A fluoroelastomers.

3. The fluoroelastomer blend of claim 2 in which no more than 50% of the total fluoroelastomer is the Type B fluoroelastomer.

4. The fluoroelastomer blend of claim 1 in which the blend further comprises one or more curing agents for the Type A fluoroelastomers but not the Type B fluoroelastomer.

5. The fluoroelastomer blend of claim 4 in which the blend further comprises one or more additional compounding ingredients selected from the group including fillers, fibers, processing aids, adhesion promoters, colorants, and plasticizers.

6. The fluoroelastomer blend of claim 1 in which the Type A fluoroelastomer comprises a peroxide crosslinkable FKM.

7. The fluoroelastomer blend of claim 6 in which the FKM makes up from about 50 to about 95% of the total fluoroelastomer.

8. The fluoroelastomer blend of claim 1 in which the Type B fluoroelastomer comprises non-peroxide-crosslinkable FKM.

9. The fluoroelastomer blend of claim 8 in which the non-peroxide-crosslinkable FKM makes up from about 5 to about 50% of the total fluoroelastomer.

10. The fluoroelastomer blend of claim 1 in which the Type A fluoroelastomer is a peroxide crosslinkable FKM that makes up the majority of the total fluoroelastomer, and the Type B fluoroelastomer is non-peroxide-crosslinkable FKM that makes up less than the majority of the total fluoroelastomer.

11. The fluoroelastomer blend of claim 1 in which the Type A fluoroelastomer is a peroxide crosslinkable FKM that makes up from about 50 to about 95% of the total fluoroelastomer, and the Type B fluoroelastomer is non-peroxide-crosslinkable FKM makes up from about 5 to about 50% of the total fluoroelastomer.

12. The fluoroelastomer blend of claim 10 in which both FKMs have the same weight percent fluorine within about ±0.5%.

13. The fluoroelastomer blends of claim 12 in which both FKMs have the same glass transition temperature within about ±2° C.

14. The fluoroelastomer blends of claim 13 in which both FKMs have the same weight percent fluorine within about ±0.2%.

15. A fluoroelastomer blend comprising one or more peroxide crosslinkable FKMs that together make up the majority of the total fluoroelastomer, and one or more non-peroxide-crosslinkable FKMs that makes up less than the majority of the total fluoroelastomer, and further comprising one or more curing agents for the peroxide crosslinkable FKMs but not for the non-peroxide-crosslinkable FKMs.

16. The fluoroelastomer blend of claim 15 in which the peroxide crosslinkable FKM makes up from about 50 to about 95% of the total fluoroelastomer, and the non-peroxide-crosslinkable FKM makes up from about 5 to about 50% of the total fluoroelastomer.

17. The fluoroelastomer blend of claim 16 in which both FKMs have the same weight percent fluorine within about ±0.5%.

18. The fluoroelastomer blends of claim 17 in which both FKMs have the same glass transition temperature within about ±2° C.

19. The fluoroelastomer blends of claim 18 in which both FKMs have the same weight percent fluorine within about ±0.2%.

20. The fluoroelastomer blend of claim 15 in which the blend further comprises one or more additional compounding ingredients selected from the group including fillers, fibers, processing aids, adhesion promoters, colorants, and plasticizers.
